(19) United States
(12) Patent Application Publication
(10) Pub. No.: US 2002/0052835 A1
(43) Pub. Date: May 2, 2002

(54) On line loan process

(76) Inventor: Paul James Toscano, Salt Lake City, UT (US)

Correspondence Address: PAUL TOSCANO, 941 EAST TAHNIA PARK CIRCLE, SALT LAKE CITY, UT, 84121, US

(21) Appl. No.: 09/845,622

(22) Filed: Apr. 30, 2001

Related U.S. Application Data
(60) Provisional application No. 60/200,890, filed on May 1, 2000.

(51) Int. Cl. G06F 17/60

(52) U.S. Cl. 705/38

(57) ABSTRACT

The On Line Loan Process (“Invention”) is a method for the on line processing of loan documents and information (collectively “Loan Documents”) that (1) allows the solicitation, verification, grant, extension, renewal and sale of loans, secured or unsecured, (2) combines law and technology, (3) preserves the persistence, provenance, integrity, legality, utility, evidentiary admissibility, form and content of Loan Documents, (4) allows such loans to be applied for, processed, ferified, approved, closed, sold, and transmitted in whole or in part by Internet, World Wide Web, wide area networks, wireless or other telecom systems, (5) allows for on line solicitation, processing, signing, reposition, and archiving of data, and (6) achieves process acceptability by the real estate and mortgage industry. The Invention incorporates encryption (not limited to public key encryption and infrastructure) personal identity authentication of digital signatures/certificates, and private data management systems and repositories.

### BACKGROUND OF THE INVENTION

The Invention pertains the field of endeavor of the solicitation, processing, approval, and extension of credit to qualified loan applicants. The Invention allows these processes, traditionally conducted with ink and paper, to be conducted electronically by means of the Internet, the World Wide Web, wireless and other telecommunications systems.

As personal computers and the Internet, network, wireless, and other telecommunications technologies have become more widely used, the need has increased for cost-effective safeguards that preserve the security of transmissions, the privacy of personal, sensitive, or legally-significant information, and the integrity and reliability of documents and related information. There has been a concomitant increase in the need for the web enabling of traditional paper processes. In light of these advances, it is no longer practical for many individuals and businesses to generate, collect, record, process, use, and store information without encoding the information in a computer-usable, electronic form. Nor is it practical for many individuals and businesses to continue to employ traditional paper business processes now that it is possible for many traditional paper processes to be conducted in electronic or digital form using these new telecommunications technologies.

The Invention presents a means by which a particular paper process—the processing of loans and mortgage loans—may be conducted entirely or in part in digital or electronic form using any of a number of telecommunications technologies in an environment that is technologically secure and legally private and reliable. The Invention allows users to create, upload, view and collaborate on digital and electronic documents in most formats; it allows these documents to be “initialed” with electronic or digital signatures so that the content and form of the document is rendered persistent; it allows these documents to be executed with legally-binding and non-repudiable electronic or digital signatures by parties to be bound by the documents and by parties approving the form and content of the documents, and by parties witnessing or authenticating the documents or signatories thereto; it allows the documents to be reposed for short periods or archived for long periods of time; it allows documents packages to be transmitted to interested parties; and it allows documents to be reposed with trustee custodians; and it allows documents to be date-stamped, time-stamped, and signed by these trustee custodians in order to create “originals” with a traceable and reportable chain of custody and certifiable to courts and other authorities.

Specific documents related to the Invention are:

| U.S. Pat. No. | Date | Inventors | |
|---|---|---|---|
| 5157726 | October 1992 | Merkle, et al. | 380/23 |
| 5390247 | Feburary 1995 | Fischer | 380/25 |
| 5544255 | August 1996 | Smithies et al. | 380/23 |
| 5579393 | November 1996 | Conner et al. | 380/25 |
| 5615268 | March 1997 | Bisbee et al. | 380/25 |
| 5872848 | Feburary 1999 | Romney et al. | 380/25 |
| 6044462 | March 2000 | Zubeldia et al. | 380/25 |
| 6085322 | July 2000 | Romney et al. | 380/21 |

These inventions do not constitute an end to end solution for enabling the electronic solicitation, processing, closure, and sale of loans and mortgage loans, although some of the inventions in the above list attempt to address some of the problems in conducting some segments of an on line loan process.

The Invention provides the method for conducting all aspects of the loan process, from solicitation to closing and loan sale to the secondary lending market. The Invention provides the following unique features and benefits:

(1) a means to collect and assemble related and verifying documents from various sources in nearly any format in a collaboration environment, (2) a means to restrict access to documents to authorized parties only in a data vaulting environment, (3) a means for professionals and parties to view documents with privacy in a restricted viewing environment, (4) a means for parties to affix to selected documents non-legally-binding electronic or digital signatures for purposes of fixing the form and content of documents for later execution in the presence of a loan closing officer with the legally-binding electronic or digital signature(s) of the signing party(ies) in a closing or signing environment, (5) a means for signing parties to affix legally-binding electronic or digital signature(s) at another point in the loan process either in or out of the presence of a loan officer, and a means for vaulting in an off line or on line environment, which vaulting includes shorter-term reposition or longer-term archiving of such documents and related information, (6) a means of transmitting relevant documents for recordation or for sale to loan purchasers or other parties, and (7) a means for elimination of the documents to meet records retention and destruction requirements.

### BRIEF SUMMARY OF THE INVENTION

The Invention relates to systems and methods for the on line processing of loan documents and related information (hereinafter collectively “Loan Documents”) involved in the solicitation, verification, approval, grant, extension, renewal and sale of loans, secured or unsecured.

### BRIEF DESCRIPTION OF THE SEVERAL VIEWS OF THE DRAWING

Attached as Exhibits “A” and “B” are two drawings of the on line loan process. Exhibit “A” describes the various computer applications that may be involved implementing the Invention, while Exhibit “B” describes the various major steps of the Invention from the point of loan solicitation to transmittal and archiving of final Loan Documents,

### DETAILED DESCRIPTION OF THE INVENTION

The Invention includes the systems and methods for soliciting loan applications, collecting relevant information from pertinent parties, verifying such information, creating or assembling related or verifying documents, preparing Loan Documents for review and execution, executing loan documents and related information with legally binding signatures, reposing and transmitting such Loan Documents to loan processors, purchasers or other parties, and archiving such Loan Document on behalf of authorized parties.

More specifically, the present Invention relates to systems and methods operating in a technological and legal environment in which (1) such Loan Documents may be processed entirely or partly in an Internet, network, wireless, or other telecommunication environment; (2) all or part of the Loan Documents are in digital or electronic form; (3) all or part of the system and methods for the preparation, signing, witnessing, using, reposing, archiving, and transmission of such Loan Documents are conducted digitally or electronically; (4) all of the foregoing systems and methods as well as all or part of the Loan Documents are rendered secure, private, or reliable by the use of passwords, cryptographic keys, public key cryptography and infrastructure, or legal-based or fiduciary-based data management vaulting and processing systems; (5) one or more passwords, cryptographic keys, public keys are employed by one or more entities (a) to assure the identity of parties preparing, creating, altering, reviewing, executing, witnessing, processing, using, reposing, transmitting, or archiving such Loan Documents or related information or (b) to assure the accuracy, security, reliability, form, content, persistence of form and content, chain of custody, evidentiary admissibility, archival status, records retention status, or the date, time, place and mode of execution thereof.

The purpose of the Invention is to allow property buyers, sellers, property agents, brokers, and other professionals, mortgage brokers, lenders, and other professionals, title companies, escrow agents, notaries, attorneys, closing agents, title insurance providers, agents, brokers, underwriters, and other professionals involved in the property mortgage industry (hereinafter jointly and severally “Parties”) to enjoy security and privacy (1) in the creation, uploading, and collaboration of such documents, (2) in the access, retrieval, and viewing of such documents, (3) in the electronic initialing or signing of such documents using electronic or digital signatures, (4) in the use, processing, management and administration of such documents and related information, and (5) in the reposition, archiving, warehousing, retention, and destruction of such documents that form part of or are pertinent to the loan process.

[image]

[image]

[image]

[image]

[image]

1. What is claimed for the Invention is a method:
a. Employing electronic or digital loan application forms, or data gathering methods, or information matrices, or related information (hereinafter “Loan Documents”);
b. Using one or more passwords, cryptographic keys, electronic or digital signatures/certificates (hereinafter collectively “Digital Signature” regardless of whether the reference is in the singular or plural) for the purposes of access to Loan Documents for purposes of signing, identifying, or rendering unalterable such Loan Documents;
c. Authenticating at authentication levels acceptable to pertinent parties to the loan process (hereinafter “Parties”) the identity of any applicant of any Digital Signature employed in the loan process;
d. Issuing Digital Signatures to the Parties;
e. Transmitting over the Internet, the World Wide Web, wide area network, wireless, or other telecommunications system of one or more Loan Documents signed with or identified by a Digital Signature;
f. Assembling or facilitating the assembling of one or more Loan Documents into electronic or digital file(s) (hereinafter “Closing File”);
g. Allowing for the collaboration by Parties and other authorized parties in the creation, uploading, viewing, downloading, approval of the Closing File and/or its contents;
h. Allowing, optionally, the submission of application for Digital Signatures at any level of authentication by one or more of the Parties or other authorized entities;
i. Allowing the setting of a date, time, and place for any off line (out of band) portion of the loan process, or in the alternative, dispensing with the off line (out of band) portion of the loan process;
j. In the event the date, time, and place for the of line (out of band) portion of the Loan Process is set, then implementing the off line (out of band) portion of the loan process by a notary, closing officer, title agent, registration authority, or other duly authorized person (hereinafter the “Officer”);
k. Allowing, optionally, the authentication by the Officer of the identity of the applicant for a legally-binding and/or non-repudiable Digital Signature according to protocols and predicated upon identifying documents acceptable to all of the requiring Parties, including without limitation a face-to-face contact between the Officer and the applicant for the legally-binding and/or non-repudiable Digital Signature in an off line (out of band) environment;
l. Allowing for the issuance of legally-binding and/or non-repudiable Digital Signature to the applicant therefore on a smart card, token, or other acceptably secure and private fixed medium either in our out of the presence of the Officer;
m. Allowing the use of any of the aforesaid Digital Signatures to initial and/or to sign the Loan Documents or Closing File in a signing environment in or out of the presence of the Officer;
n. Allowing, optionally, for the vaulting, either in the form of short-term reposition or long-term archiving, of digitally initialed or signed Loan Documents; and
o. Allowing, optionally, for the transmittal of the electronically or digitally initial or signed Loan Documents to other entities as authorized by the Parties or authorized entities;
p. Allowing, optionally, for the final archival management, records retention, and eventual document destruction of the digitally initialed or signed Loan Documents according to policies and procedures acceptable to the Parties or authorized entities.

2. The method of claim 1, further allowing one or more Digital Signatures to be applied to a Loan Document or Closing File at different times during the loan process by the same or different entities in the presence of the Officer.

3. The method of claim 1, further allowing one or more Digital Signatures to be applied to a Loan Document or Closing File at different times during the loan process by the same or different entities outside the presence of the Officer, but in real time by means of electronic, digital, Internet, web, network, wireless, or other telecommunications technologies that may include audio and/or visual contact between any of the Parties or entities and the Officer; and

4. The method of claim 1, further allowing one or more Digital Signatures to be applied to a Loan Document or Closing File at different times during the loan process by the same or different entities outside the presence of the Officer upon condition that the authentication of the identity of the signatory of a Loan Document or Closing File using a Digital Signature was previously authenticated by protocols acceptable to the Parties, which protocols assures that the identity of the signatory employing Digital Signature to sign a Loan Document corresponds to the identifying documents provided by such signatory as part of an acceptable procedure for authenticating, certifying and issuing a pre-notarized or pre-authenticated Digital Signature and provided that applicable law recognizes the use of such pre-notarized or pre-authenticated Digital Signature on such Loan Document or Closing File.
